(19) United States
(12) Patent Application Publication
(10) Pub. No.: US 2016/0230040 A1
(43) Pub. Date: Aug. 11, 2016

(54) Transparent Ballistic Resistant Composite

(71) Applicant: Milspray LLC, Lakewood, NJ (US)

(72) Inventors: Matthew L. Johnston, Bayville, NJ (US); Kevin J. Cruz, New York, NY (US)

(73) Assignee: Milspray LLC, Lakewood, NJ (US)

(21) Appl. No.: 15/019,676

(22) Filed: Feb. 9, 2016

Related U.S. Application Data
(60) Provisional application No. 62/114,532, filed on Feb. 10, 2015.

(51) Int. Cl. C09D 175/04; F41H 5/04; F41H 5/06

(52) U.S. Cl. CPC C09D 175/04; F41H 5/06; F41H 5/0407

(57) ABSTRACT

A composition comprising clear urethane polymer that has elastomeric properties provides resistance to damage by impact from ballistic projectiles. The composition can be monolithic urethane polymer or a composite with a urethane polymer core layer and a transparent protective substrate layer adjacent one or both planar surfaces of the polymer.

### RELATED APPLICATIONS

This application claims benefit to U.S. provisional application 62/114,532, filed Feb. 10, 2015, which is incorporated herein by reference.

### FIELD OF THE INVENTION

This invention relates to ballistic shields. More specifically, it relates to a transparent composite polymeric core layer for ballistic shields that can safely absorb impact from weapons-grade projectiles, shrapnel and other ballistic projectiles. The invention also may comprise a layer of material external to the core layer that protects the core layer.

The invention also may relate to a clear polymeric coating that can be applied to infrastructure substrates, such as metal, stone or concrete construction components, such as building foundations or bridge supports, so as to protect the surface of those substrates and to provide visual inspection of the physical condition of the substrate material.

### BACKGROUND OF THE INVENTION

Aggressive threats to people and property exist in modern society from a wide variety of military and civilian activities. In the military and police spheres, personnel and equipment carrying out operations are subject to attack by offensive ordnance, explosive devices and accompanying shrapnel. Apart from the military, people, business installations and homes are exposed to similar ballistic attack resulting from criminal activity, social unrest, irrationally aggressive behavior and the like. Thus, there is a need to protect persons and property from the impact by ballistic projectiles.

Traditional ballistic shields are frequently thick, heavy and rigid sheets that resist ballistic impact largely due to their hard and robust structure. A need exists for thinner, lighter and more versatile ballistic shields that retain the functional ballistic resistance of traditional ballistic shields.

Additionally, many existing ballistic shields are visually opaque so that a person protected by a shield cannot view a threat on the other side of the shield. Opaque shields are thus less desirable for applications such as window protection. The manufacture of new traditional windows or the retrofitting of existing non-ballistic resistant windows, in either case comprising glass and/or rigid transparent plastic, for example, acrylic/poly(methyl methacrylate) sheet, wherein the windows can be rendered ballistic resistant is of interest to the security, police and defense industries and to others. A need exists to economically and effectively install a transparent ballistic shield over or within an existing non-ballistic window to provide ballistic protection while substantially maintaining transparent properties of the window.

Destructive forces are increasingly affecting the integrity of elements of civil engineered and architectural infrastructure, such as building foundations, bridge support columns and the like. Intentional and accidental destruction from such causes as malicious or military explosive detonations and accidental collisions can severely damage the strength of such infrastructure elements. Wear and tear caused by age and normal use and environmental exposure can also damage infrastructure elements such as building foundations, utility towers and culverts, roadway structures and the like. Weakened and deteriorating structures, especially those of cured solid construction material such as concrete and cement, is often manifested as spalling, in which surface cracks appear and propagate and the surface layers chip and flake off.

A traditional method of protecting against deterioration is to coat the completed surface with a thin layer of a coating material. Conventional coating materials are typically opaque, typically due to the natural opacity of resins or the incorporation of high density fortifying fillers or fibers. Although the coating may be less than ten mils in thickness, preferably less than five mils in thickness, more preferably less than one mil in thickness, deterioration such as spalling below the coating cannot be observed by visual inspection because of coating opacity. Testing for structural defects thus requires application of expensive, sensitive, and technologically sophisticated analytical instrumentation with trained and skilled technicians to evaluate the results. Accordingly, there also exists a need for a clear protective coating on surfaces of elements of infrastructure to enable defects developing below the coating surface to be detected by simple, external visual inspection.

### SUMMARY OF THE INVENTION

A ballistic resistant polymeric composition may be present as an internal core layer of a multilayer composite having a transparent, more rigid plastic substrate, such as poly(methyl methacrylate), or glass outer substrate layer that protects the core layer from environmental damage from scratches, dirt, pollution, and weather caused by exposure to abrasion, wind, rain, ice, and sun. The polymeric composition also can be present in multiple layers alternating between glass and polymer, or as a coating to a single side of a transparent substrate. The composite can be applied directly on an existing window glazing structure to increase ballistic protection of the window and interior occupants or property. The composite optionally also may include a second layer of more rigid plastic or glass facing the opposite surface of the composite, so that the window glazing comprises a hard surface on opposite sides of the ballistic energy absorbing polymeric barrier core layer. This dual skin composite can serve as a ballistic resistant window in a new building or vehicle installation. Alternatively, it can be a complete substitute for an existing non-ballistic resistant glazing structure that is removed and replaced by the dual skin composite.

The single-skin or dual-skin layer clear ballistic composite also can provide heat transfer resistance compared to standard glazing structure to provide moderate thermal conservation enhancement. Moreover, it is possible to apply the composite to a single transparent, rigid flat or curved sheet, such as glass, then place a second transparent, rigid sheet adjacent to, but not in direct contact with, the first sheet, leaving an air or other gas space between the composite and the second sheet, analogous to the arrangement of glass sheets in traditional multipane thermal windows. Of course, it is possible to have such glass arrangements comprising two, three or more sheets of glass, with ballistic composite between some or all of the panes, each pair of adjacent sheets separated by any of ballistic composite, air, inert gas, transparent plastic insulation or any other material commonly used to construct windows, including thermal windows.

This invention also provides a clear polymeric composition that can be applied as a coating on the surface of metal, wood, stone, concrete and similar materials of support structures for buildings, bridges, and tunnels, and for pipes (above or below grade), fluid storage tanks, chemical emission stacks, material silos, dams, retaining walls, and the like. The clear coating can protect the surface from long-term environmental insults from dirt, pollution and weather. It has elastomeric properties that allow it to deform with the substrate structure. Being clear, the coating features the ability to view near surface defects in the underlying structure for rapid, simple visual inspection.

### BRIEF DESCRIPTION OF THE SEVERAL VIEWS OF THE DRAWINGS

FIG. 1 is a photograph of a view of the disc of clear ballistic resistant urethane polymer composition of Example 1 that had been impacted by a .22 caliber bullet fired from a Long Rifle cartridge.

FIG. 2 is, a photograph of an oblique vertical view of the disc of FIG. 1 positioned on a graphic array of finely drawn lines visible through the disc and presented to demonstrate optical clarity of the disc.

FIG. 3. is a plot of stress versus strain data of discs made according to Example 1.

FIG. 4 is a photograph of an oblique side view of a disc of clear ballistic resistant urethane polymer composition according to comparative Example 2 that had been impacted by a .22 caliber bullet fired from a Long Rifle cartridge, demonstrating greater depth of bullet penetration than that of Example 1 and polymer fracturing near and around the entrapped bullet.

FIG. 5 is a plot of stress versus strain data of discs made according to Example 2.

FIG. 6 is a photograph of an oblique vertical view of the disc of clear ballistic resistant urethane polymer composition according to comparative Example 3 that had been impacted by a .22 caliber bullet fired from a Long Rifle cartridge and demonstrating greater depth of bullet penetration than that of Example 1 and polymer fracturing near and around the entrapped bullet.

FIG. 7 is a plot of stress versus strain data of discs made according to comparative Example 3.

FIG. 8 is a photograph of an oblique top view of the disc of clear ballistic resistant urethane polymer composition according to comparative Example 4 that had been impacted by a .22 caliber bullet fired from a Long Rifle cartridge and demonstrating greater depth of bullet penetration than that of Example 1 and polymer fracturing near and around the entrapped bullet.

FIG. 9 is a plot of stress versus strain data of discs made according to comparative Example 4.

FIG. 10 is a photograph of an oblique vertical view of the disc of clear ballistic resistant urethane polymer composition according to comparative Example 3 that had been impacted by a 9 min caliber bullet and demonstrating fracturing characteristics at higher energies.

FIG. 11 is a side view photograph of clear ballistic resistant urethane polymer composition showing alternating layers of glass and polymer consisting of one layer of urethane polymer, and two layers of glass.

FIG. 12 is a photograph of an oblique vertical view of the of clear ballistic resistant urethane polymer composition with the addition of a catalyst, revealing a slight yellowing.

FIG. 13 is a photograph of a ¼ inch layer of urethane polymer composition between two panes of float glass.

FIG. 14 is a diagram illustrating elements of a commercially available thermal window.

FIG. 15 is a photograph of two panes of float glass with a ¼ inch layer of urethane polymer composition impacted by a .38 caliber full metal jacket bullet stopped near its nearer pane of glass.

FIG. 16 is a photograph of a ¼ inch layer of urethane polymer composition between two panes of float glass shot with a 9 mm bullet on the near side and a .22 caliber bullet fired from a Long Rifle cartridge on the reverse side with no complete polymer penetration.

FIG. 17 is a photograph of a ¼ inch layer of urethane polymer composition between two panes of float glass showing a hole created by a 9mm caliber full metal jacket bullet and demonstrating that small bubbles introduced during processing can cause micro-fracture failure.

### DETAILED DESCRIPTION OF THE INVENTION

“Ballistics,” as used herein, is the science of mechanics that comprises launching, flight, behavior, and effects of projectiles, especially bullets or the like. A “ballistic” or “ballistic projectile”, as used herein, is such a projectile having momentum, wherein its flight characteristics are subject to forces such as the pressure of gases similar to those generated in a firearm or a propulsive nozzle, rifling in a barrel, gravity, or drag as that typically imposed by air.

“Ballistic resistance,” as used herein, means resistance to impact from a projectile measured according to the protocol of the U.S. Department of Justice, National Institute of Justice standard 0108.01, “Ballistic Resistant Protective Materials, NIJ Standard 0108.01” (September 1985).

A “ballistic resistant composite” or “ballistic resistant composition,” as used herein, is a transparent synthetic polymeric composition having elastomeric properties sufficient to absorb impact of a ballistic projectile. As used herein, “transparent” or “clear” refers to the property of the composite or composition material wherein an object can be adequately visually viewed through the material for the purpose for which the viewing is intended.

A polymer as described herein provides a protective coating that enables an observer to obtain a visually transparent observation of that structure. The structure may be a substrate to which the transparent protective polymer is applied, for example, concrete, metal, plastic, wood or glass, or the structure may be a part of an assembly for which a freely suspended or fastened quantity of cured polymer is incorporated, such as used in place of, or as an adjunct to, window glass, bullet proof or bullet resistant glazing, a bullet proof shield as typically used by military or police, a structural component, or a safety shroud, such as protection around equipment. Such a component or structure may require visual observation of one or more of its functions of operation, but also may require protection from that function of operation, for example, testing materials likely or intended to shatter or explode.

The composition of the core layer of the novel clear ballistic composite is polymeric. Preferably, the polymer is a urethane polymer containing urethane groups (—NHCOO—) in some or all repeating units of the polymer chain. Other groups that may be present include esters, ethers, amides and ureas. The urethane polymer preferably is produced by reaction of a diisocyanate with monomeric or polymeric polyol.

A urethane polymer composition for use in the composite described herein is formed by reaction of aliphatic; polyisocyanate resin, including 1,6-hexamethylene diisocyanate and cycloaliphatic, 4,4′-dicyclohexylmethane diisocyanate with a polyester polyol. Polyester polyols may be selected from the group of the K-FLEX® AND K-POL® Polyester Polyol family of products (King Industries, Inc., Norwalk, Conn.). These products include K-POL 8211, K-FLEX types 188, 148, 171-90; A307, A308, XM 332, XM-337, XM-366 and XM-367. Representative 1,6-hexamethylene diisocyanates include DESMODUR® N 3300 and N 3900 (Bayer Material Science LLC, Pittsburgh, Pa.) and cycloaliphatic, 4,4′-dicyclohexylmethane diisocyanate, which includes Desmodur W.

Urethane polymer compositions may utilize the formulations of isocyanate and polyol components shown in Table I or Table II, below.

TABLE I

| | Isocyanate | | Polyol |
|---|---|---|---|
| Isocyanate blend | equivalent | Polyol blend | equivalent |
| components | weight % | components | weight % |
| 4,4′-dicyclohexylmethane | 73 | Polyester Polyol 188 | 95 |
| diisocyanate¹ | | | |
| 1,6-hexamethylene | 23 | Polyester Polyol 366 | 3 |
| diisocyanate² | | | |
| 1,6-hexamethylene | 4 | Polyester Polyol 337 | 2 |
| diisocyanate³ | | | |

¹= Desmodur W
²= Desmodur N3300
³= Desmodur N3900

TABLE II

| | Isocyanate | | Polyol |
|---|---|---|---|
| Isocyanate blend | equivalent | Polyol blend | equivalent |
| components | weight % | components | weight % |
| 1,6-hexamethylene | 100 | Polyester Polyol 8211 | 92 |
| diisocyanate² | | Polyester Polyol 188 | 5 |
| | | Silquest A-189 silane | 1 |
| | | Urethane grade acetone | 2 |

Additions to the urethane polymer formulations may also include (a) gamma-mercaptopropyltrimethoxysilane (SILQUEST™ A-189 silane, Momentive Performance Materials, Inc., Waterford, N.Y.), typically at about 0.4 wt % of total isocyanate and polyol mass, and (b) methyl amyl ketone typically at about 2.5 wt % of total isocyanate and polyol mass.

In addition, a blocking agent, such as dimethylpyrazole (Wacker Chemie AG, Munich, Germany) can be used to inhibit the reaction between the isocyanate components and other reactive components. A blocking agent would allow the mixture to be used as a single component coating for application.

In other embodiments, the rate of cure of the urethane polymer can be increased with the use of K-cat catalysts products of (King Industries, Inc., Norwalk, Conn.). The addition of the catalyst causes a more rapid cure with the same ballistic protection and a slight yellowing of the material as seen as polymer disc darkening in FIG. 12.

The preferred urethane polymer can be prepared as shown in the Examples, below. Generally, the three isocyanate components are mixed to form an isocyanate blend. The three polyol components are mixed to form a polyol blend. Methyl amyl ketone and the silane are mixed in a container until homogeneous. The isocyanate blend is added to the container and agitation continued until a homogeneous mixture is obtained. Then, the polyol blend is added to the container and agitation continued until a homogeneous mixture again is obtained. The resulting mixture is degassed until all readily detectable volatile components have been removed from the mixture. The uncured mixture in liquid form then is coated onto the surface of a substrate. As used herein, as substrate may be considered any surface that will support the uncured liquid mixture while it cures and that will not substantially inhibit its curing. A substrate preferably is transparent glass, but a substrate may be a transparent plastic such as acrylic/poly(methyl methacrylate), or a substrate may be any solid or even a liquid surface, including a shaped or planar mold or sheet, so long as the substrate physically supports the uncured mixture and does not substantially inhibit curing. Coating the uncured mixture onto a substrate can be accomplished by any conventional urethane coating technique such as, but not limited to, casting, pouring, brushing, transfer roll coating, spraying, doctoring and dip coating.

Alternatively, processing of the urethane polymer can be conducted by using a two component cartridge filled pneumatic gun, whereby the isocyanate blend is loaded into one cartridge and the polyol blend into the other cartridge. Operation of the pneumatic gun forces the two components through a static mixer of sufficient length to allow for complete mixing.

Alternatively processing of the urethane polymer can be conducted by using a temperature controlled reaction vessel in which the materials can be maintained at constant temperature and can be mixed while under vacuum.

In other preferred embodiments, the rate of cure of the urethane polymer can be increased with the use of K-cat catalyst products (King Industries, Inc., Norwalk, Conn.). The addition of a catalyst causes a more rapid cure with similar ballistic protection and a slight yellowing of the material as seen in FIG. 12.

The urethane polymer employed provides superior ballistic resistance. Ballistic resistance of the urethane polymer is demonstrated, for example, by pouring the fluid, uncured mixture described above into a cylindrically shaped, uncovered mold of about 3.5 inches diameter by about 1 inch high and allowing the mixture to cure to a clear solid disc, similar in shape to a hockey puck. When the circular face of the cured polymer disc is impacted by a 40 grain, round nose .22 caliber bullet fired from a Long Rifle cartridge at a distance of 5 meters and having an impact velocity of 1250 feet per second and impact energy of 189 Joules fired, the bullet penetrated the disc to a depth of only 0.375 inch. “Self-healing” phenomenon was observed at the point of impact on the surface of the disc as elastic modulus properties of the urethane polymer caused the impacted bullet after entry into the disc to rebound toward the impact surface. The self-healing, also referred to as “self-sealing”, and generally elastic nature of the urethane polymer structure allows entrapment of the incoming projectile. The projectile entrapment performance also indicates that ballistic articles have enhanced projectile ricochet and shrapnel protection near the site of impact. The self-healing feature also provides the urethane polymer ballistic material applied to the surface of a fluid-filled container or pipe with ability to reduce or prevent escape of liquid or gas from the container that is impacted by a ballistic projectile.

In another embodiment the urethane polymer may be positioned as a ballistic resistant layer adjacent to one, or between two or more, conventional transparent sheets, for example, of glass or plastic, wherein the plastic preferably is a poly(methyl methacrylate) such as Plexiglas®. A contemplated utility for this embodiment is commonly referred to as safety glass or laminated glass and may be used for windows to safely view within barricaded areas where operations are carried out with potentially explosive or otherwise hazardous materials. When glass is used, the glass may include any of float glass, annealed glass, heat tempered glass, or chemically tempered glass.

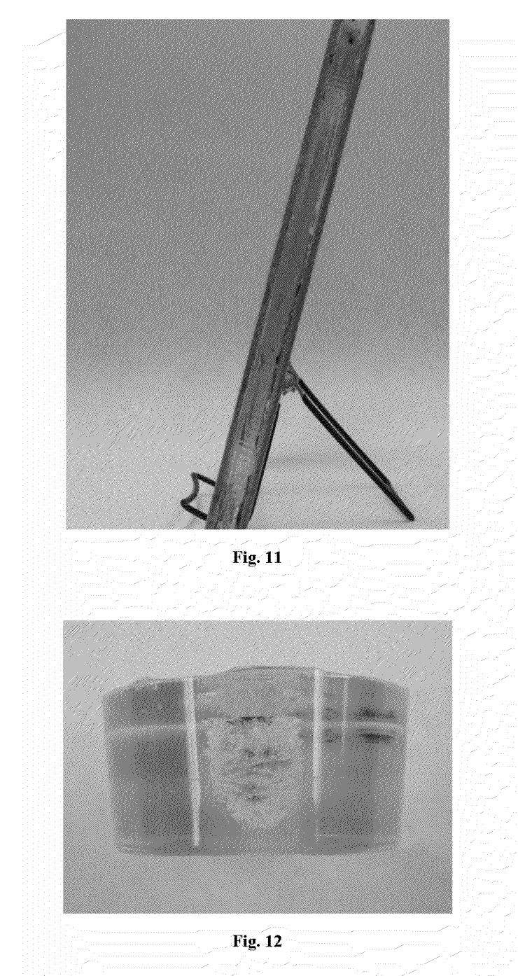

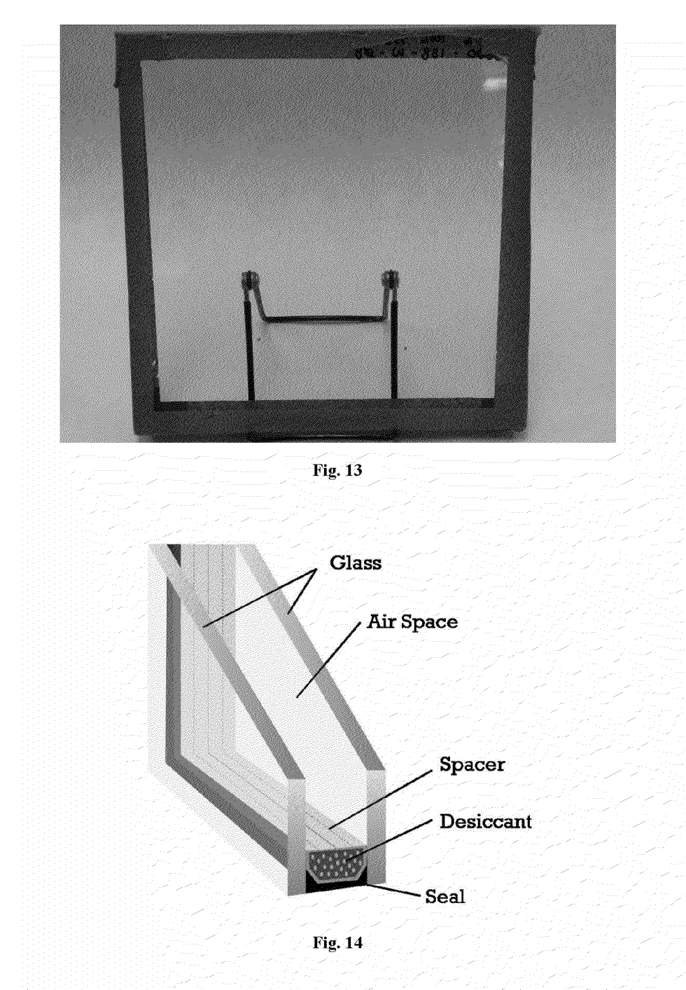

In this preferred embodiment, the polymer may act as an anti-spalling medium between commercial applications of panes of glass or plastic, such as by polymerizing the polymer within the one of more air spaces commonly present in commercial insulated or thermal windows, and further may function as an impact absorption and energy mitigation layer between commercial panes of glass to transform ordinary glass into a laminar ballistic glass composite (see, for example, FIGS. 11 and 13). Applicant has found that this embodiment functions as an aftermarket ballistic resistant application comprising rendering existing thermal windows ballistic resistant.

In a related and especially preferred embodiment, the transparent urethane polymer may be retrofitted into an existing multipane thermal window to render the existing window ballistic resistant. This embodiment advantageously applies to thermal windows already installed or to be installed in a home, business or government building, where ballistic resistant windows are desired. Uncured urethane polymer may be injected into the air space of a thermal window as illustrated in FIG. 14 (©GLASS DOCTOR® 2016) via a hole drilled through a seal or through one of the glass panes, preferably through or near a lower seal of the thermal pane, while allowing air or other gas to escape the air space via a similar hole positioned through or near an upper seal of the thermal pane, thereby replacing the air or other gas in the air space with uncured urethane polymer. The drilled holes optionally can be filled once the process is complete. Alternatively, one of the glass panes may be temporarily removed from the window so that the uncured urethane polymer may be applied to a remaining glass pane in any manner described herein, allowed to cure, then the glass pane may be replaced. Because many thermal windows are readily removable from the building in which they are installed, installation of the transparent urethane polymer can be a relatively simple process. Once the air space is filled with transparent urethane polymer, the thermal window, which now is ballistic resistant, may be reinstalled.

In another related embodiment, the polymer may comprise part or all of a laminate between the curved or flat sheets of glass that comprise a windshield or other substantially transparent structure of a vehicle, such as an automobile, truck, military vehicle, railroad locomotive or passenger car, aircraft or the like. The addition of a suitable thickness of the polymer can impart bullet resistant or increase impact resistant qualities to windshields of vehicles subject to impact not only of bullets, but also of large or heavy objects such a stones or bricks.

Because the polymer of the invention possesses a refractive index similar to that of glass, wherein the windshield may consist essentially only of one inner and one outer glass or plastic pane between which the polymer is laminated, this embodiment allows an observer to visualize objects on the opposite side of the glass at oblique angles, as in FIG. 2, rather than only near perpendicular to the glass surface. Historically, objects may be usefully viewed through traditional multilaminate bullet proof glass only from an angle very near perpendicular to the surface of the glass.

Additionally, ballistic impact tends to fracture traditional bullet proof glass to a degree that even though the projectile might not penetrate all of the glass layers, the degree of fracture is so extensive as to render the impacted glass as functionally opaque. The inventors have noticed that the degree of fracture extending in the glass of the present invention away from the immediate area of impact is substantially less. Capitalizing on this anti-fracturing quality using a dramatic example, while both this embodiment of the present invention and traditional bullet proof glass can protect the occupants of a vehicle from ballistic projectiles, the occupants of the vehicle protected by the present invention are more likely to be able to see through their windshield to a path of safety.

The polymer also may act as a superficial coating on single-pane glass or plastic, which then optionally may be overlaid with a more abrasion resistant and/or rigid transparent material, such as glass or plastic, since the polymer tends to be softer than glass and my be more subject to abrasion.

In other embodiments, the urethane polymer can be applied to fracturable substrates such as metal, wood, brick, masonry, plastic, concrete, cement, and glass. When applied to such substrates, the polymer system acts as an elastomeric polymer, which envelops or coats the surface of the substrate. Following fracture of such a substrate due to shock or deterioration, for example, by earthquake, impact, torsion, friction, vibration, environmental degradation, age and other sources of stress, the urethane polymer is bound to the surface of the fractured pieces to reduce crumbling and provide structural reinforcement. By holding fractured pieces together, the urethane polymer can help maintain integrity and/or reduce dirt, dust and debris contamination of the surrounding area due to the fracture.

Application to fracturable substrates can be very helpful, for example, in the field of civil engineering, where polymeric protection to concrete support structures for bridges and building foundations offers advantages. Such concrete structures conventionally either are uncoated or are coated with opaquely pigmented coatings, such as paint or asphalt. Commonly, however, concrete structures are surveyed for damage by visual inspection. After fractures are detected, surface penetrating radar is used to further evaluate the nature of those fractures. Coating structures with clear urethane polymer according to the present invention allows quicker surveying of these structures, while in many instances avoiding use of sophisticated, but slow and expensive, analytical instruments such as surface penetrating radar.

Preferably within the civil engineering context, the thickness of the urethane polymer coating is substantially uniform over the surface of the structure to which the polymer is applied. Preferably, the minimum polymer thickness is least about 3 mils, and more preferably at least about 4 mils. The maximum thickness usually is limited by the cost of polymer material. In this instance, the thickness should be less than about 500 mils, preferably less than about 400 mils, more preferably less than about 200 mils, and most preferably less than 100 mils.

### EXAMPLES

Urethane polymer compositions were prepared using material compositions formulated as in Table III, below.

The isocyanate components were mixed to form an isocyanate blend and the polyol components were mixed to form a polyol blend. Methyl amyl ketone or acetone and the silane were placed in a container and mixed with a Cowles blade rotary shear agitator at 50 to 100 rev./min until homogeneous. The isocyanate blend was added to the container and agitation continued at 650-700 rev/min until a homogeneous mixture was obtained. Then, the polyol blend was added to the container and agitation continued at 650-700 rev/min until a homogeneous mixture was obtained. All materials were maintained and mixed at about 38° F. The resulting mixture was degassed in a vacuum chamber at a pressure below 0.4 inches Hg. vacuum was maintained for approximately 8 min until all volatile components had been removed from the mixture. The uncured, liquid mixture was coated onto the surface of a glass substrate or formed into discs, as described above.

Processing at higher speed leads to greater heat generation and faster cure rates that do not allow time for proper degassing. Relatedly, slower mixing speed resulted in long time to homogeneity, resulting in beginning of curing before the uncured liquid could be applied to the substrate.

The compositions were formed into the discs, and the discs were subjected to physical property testing according to ASTM standard test D412 and ballistic resistance testing according to NIJ standard 0108.01. Results of testing Examples 1-5 (Ex 1-Ex 5) are presented in Table III, below.

TABLE III

| | Ex 1 | Ex 2 | Ex 3 | Ex 4 | Ex 5 |
|---|---|---|---|---|---|
| Sample Designation | KC8-01 | KC-07 | 09 | 10 | PD-072 |
| Desmodur-W e-wt %¹ | 73 | 49 | 25 | 25 | 0 |
| Desmodur N3300 e-wt % | 22 | 49 | 73 | 2 | 100 |
| Desmodur N3900 e-wt % | 3 | 2 | 2 | 73 | 0 |
| K-Flex 188 e-wt % | 95 | 95 | 95 | 95 | 3 |
| K-Flex 337 e-wt % | 2 | 2 | 2 | 2 | 0 |
| K-Flex 366 e-wt % | 3 | 3 | 3 | 3 | — |
| K-Pol 8211 | — | — | — | — | 96.7 |
| SILQUEST ™ A-189 silane p-wt. % ² | 0.4 | 0.4 | 0.4 | 0.4 | 0.3 |
| Methyl Amyl Ketone p-wt % | — | — | — | — | — |
| Average Stress psi | 2300 | 1150 | 1065 | 900 | 5893 |
| Axial strain % | 149 | 155 | 119 | 170 | 9.3 |
| Elastic Modulus psi | 93970 | 13402 | 15067 | 1174 | 154939 |
| Load at break, lb (force) | 66.2 | 56.4 | 46.6 | 21.6 | 39.9 |
| Load maximum lb (force) | 86.1 | 56.4 | 56.6 | 21.7 | 51.6 |
| Extention at maximum load, % | 6.01 | 151.61 | 116.50 | 163.00 | 5.63 |

¹equivalent weight %
² percent of total isocyanate and polyol mass

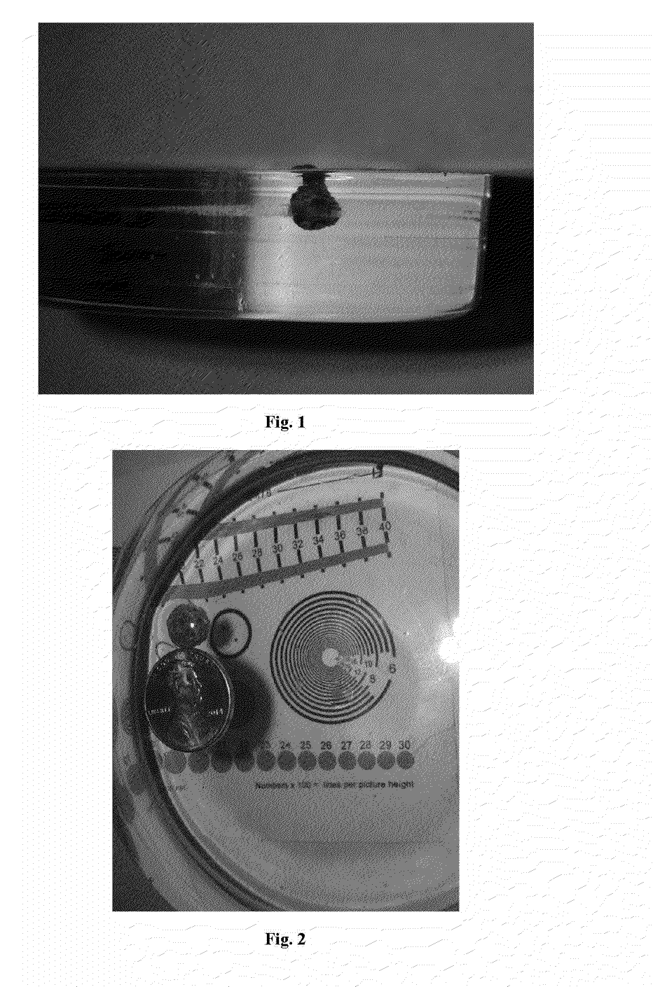

FIGS. 1 and 2 show that the urethane polymer composition of Example 1 produced only slight penetration into the sample disc and that extremely little stress fracturing occurred around the site and path of penetration within the polymer sample.

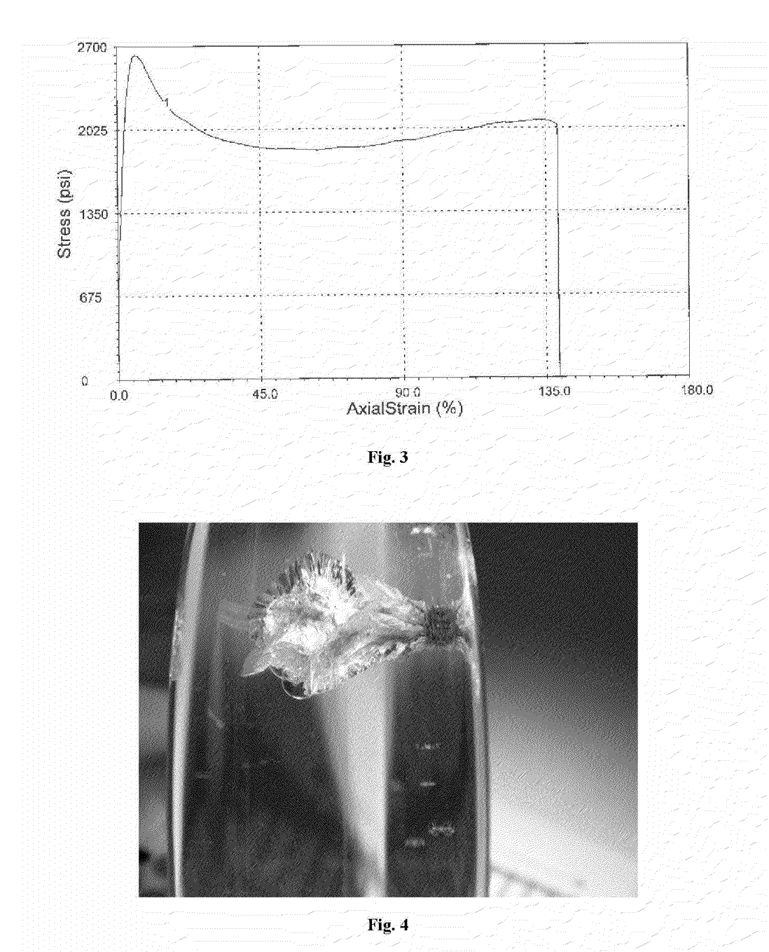

Stress versus strain data of FIG. 3 further indicate suitability of the composition of Example 1, for the utilities of this invention as follows:
A. Maximum initial tensile strength (stress) was achieved within approximately 4% to 5% elongation (strain),
B. Upon reaching initial maximum stress, the polymer began to stretch at lower tensile pressure,
C. As the polymer stretched at lower imposed stress values, the stress again increased gradually to further stretch the polymer,
D. As tensile pressure began to increase, the polymer began to yield, as illustrated by a plateau in the line graph prior to failure of the polymer, (where the stress value reaches zero and strain ceases). In the example, the polymer yielded between 80% to 90% of its maximum elongation. By way of example, should the polymer exhibit a total of 185% elongation, then the yield point was predicted to be approximately 146% to 175.5% of that total elongation value; and
E. The initial stress value was higher than the breaking stress value. This value may further be characterized by the polymer reaching its maximum stress value within the first 10% of the exhibited elongation value of that particular polymers. This value also may be characterized by exhibition by the polymer of less than 10% of its maximum elongation value for which it has reached its maximum strength.

FIGS. 4, 6, and 8 show that the urethane polymer compositions of comparative Examples 2, 3 and 4, respectively, produced greater penetration into the polymer sample than was the case with Example 1. Significant stress fracture of the polymers at the sites and paths of penetration of the projectiles also was observed. These observations led to the conclusion that performance of the compositions of comparative Examples 2 through 4 was unsuitable for the ballistic resistant utilities of the invention.

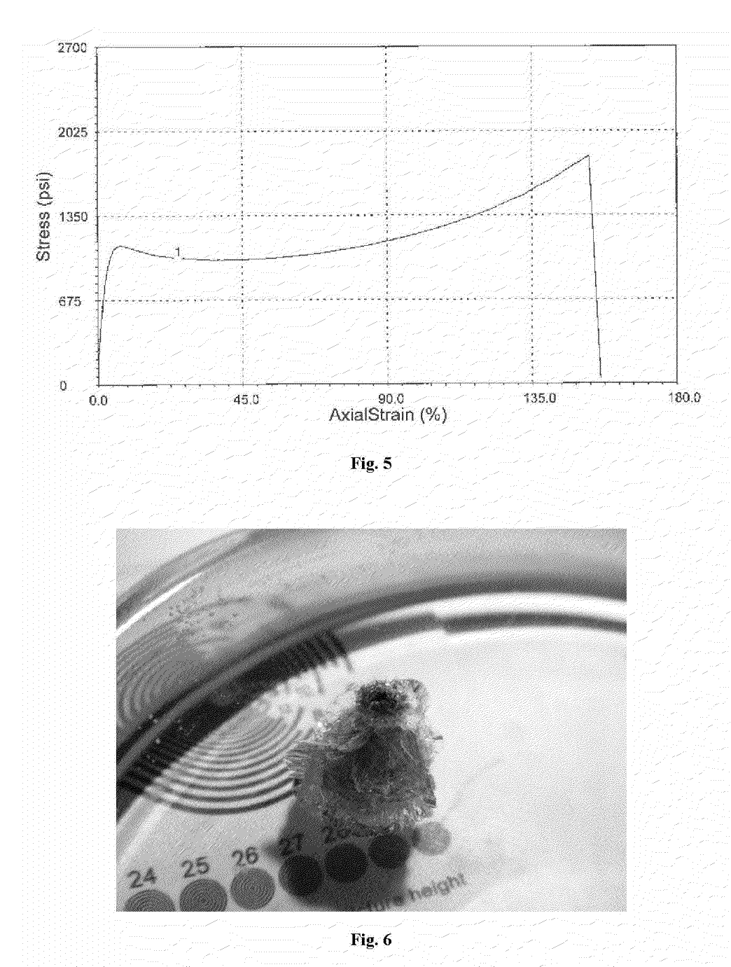

Stress versus strain data of FIG. 5 for the composition of comparative Example 2 indicates the following:
A. Maximum initial tensile strength (stress) was achieved with approximately 4% to 5% elongation (strain),
B. Upon reaching maximum initial tensile strength (stress), the polymer continued to stretch at a slightly lower tensile pressure than the maximum initial tensile pressure;
C. As the polymer continued to stretch, additional force was required to continue stretching;
D. As tensile pressure began to increase, the polymer failed. In this example no identifiable yield point was noted on the graph;
E. The stress at the breaking point was approximately 170% greater than the maximum initial stress; and
F. The initial stress value was significantly lower than the breaking stress value. This value further may be described as a condition in which for the polymer to achieve maximum strength values, it must also have achieved its maximum elongation.

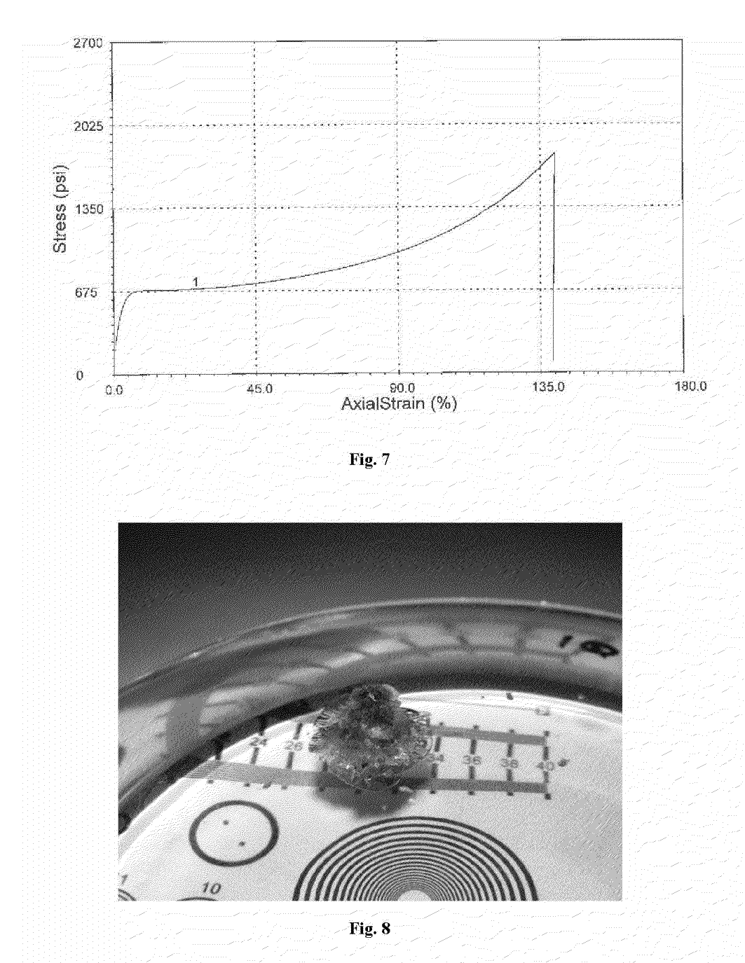

Stress versus strain data shown in FIG. 7 for urethane polymer composition of comparative Example 3 indicate the following:
A. Maximum initial tensile strength (stress) was achieved with approximately 4% to 5% elongation (strain)
B. Upon reaching maximum initial tensile strength (stress), the polymers began to stretch, but required little to no change in stress.
C. As the polymers stretched, they began to require more tensile strength to continue stretching the polymer
D. As tensile pressure began to increase, the samples finally broke, but exhibited no identifiable yield point. The stress at the breaking point was approximately 240% greater than the maximum initial stress.
E. The initial stress value was significantly lower than the breaking stress value. For the polymer to achieve maximum strength values, it also must have achieved maximum elongation.

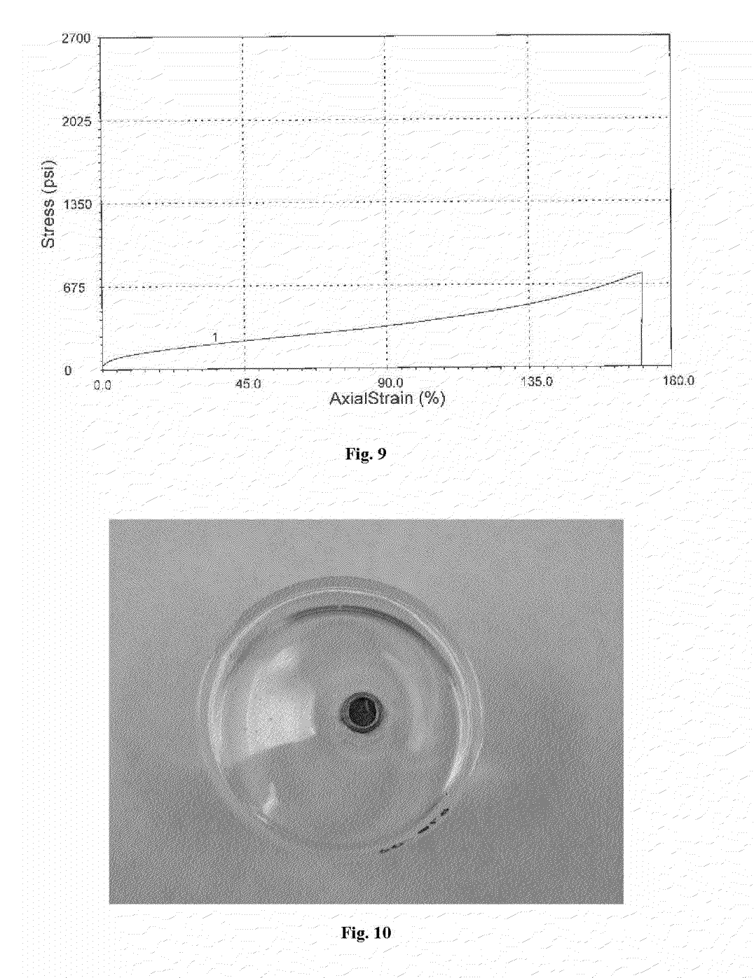

Stress versus strain data of FIG. 9 for the urethane polymer composition of Comparative Example 4 indicate the following:
A. Maximum initial tensile strength (stress) was achieved with approximately 4% to 5% elongation (strain)
B. Upon reaching maximum initial tensile strength (stress), the polymers began to stretch, but required greater tensile pressure to continue, stretching; the polymers did not relax.
C. As the polymers stretched, more tensile strength began to be required to continue stretching the polymer
D. As tensile pressure began to increase, the samples finally broke, but exhibited no identifiable yield point. The stress at the breaking point was approximately 400% greater than the maximum initial stress. The maximum stress was significantly lower than all other material formulas.

Parameters of ballistic projectiles used for Examples are shown in Table IV.

TABLE IV

| Projectile | | | Grain | Cladding & | Muzzle | Muzzle |
|---|---|---|---|---|---|---|
| Series # | Manufacturer | Description | Weight | Geometry | Velocity | Energy |
| 1 | Aguila | .22LR | 20 | LRN | 152 | 15 |
| 2 | CCI | .22 Short | 27 | CPHP | 337 | 99 |
| 3 | Eley | .22LR | 40 | FN | 331 | 142 |
| 4 | Federal | .22LR | 36 | CPHP | 390 | 178 |
| 5 | Colt | .22LR | 40 | LRN | 381 | 189 |
| 6 | Buffalo Bore | 9 mm | 147 | FMJ-FN | 305 | 442 |
| 7 | PMC | 9 mm Luger | 115 | FMJ | 351 | 458 |
| 8 | TulAmmo | 9 mm Luger | 115 | FMJ | 351 | 460 |
| 9 | Armscor | 9 mm | 124 | FMJ | 332 | 472 |
| 10 | Liberty | 9 mm | 50 | HP | 610 | 602 |
| 11 | Allegiance | 9 mm | 70 | Frangible | 500 | 666 |
| 28 | American | 9 mm | 124 | FMJ | 351 | 495 |
| 30 | Buffalo Bore | .38 special | 158 | SC, HP | 259 | 304 |

FMJ: Full Metal Jacket
FMJ-FN: Full Metal Jacket - Flat Nose
LRN: Lead Round Nose
JSP: Jacketed Soft Point
CPHP: Copper Plated Hollow Point
SC: Soft Cast
HP: Hollow Point

FIG. 13 shows the transparency of a clear layer of urethane polymer applied to two panes of glass.

FIG. 14 illustrates a diagram of a commercially available thermal window, comprising two panes of glass separated by an air space as advertised GLASS DOCTOR® (2016), which is similar to the glass arrangement of FIG. 13, but without the urethane polymer between the two panes of glass.

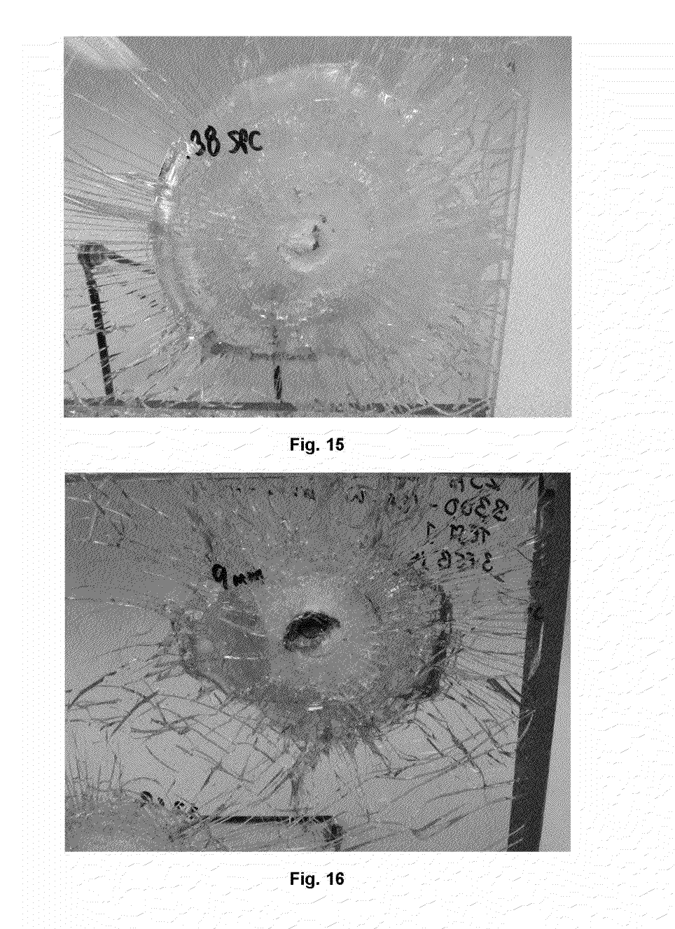

FIG. 15 demonstrates that two panes of ¼ in glass coupled with ¼ inch of polymer stopping a .22 caliber bullet fired from a Long Rifle cartridge, as well as a .38 caliber full metal jacket bullet.

FIG. 16 shows the ballistic protection against a 9 mm full metal jacket bullet and a .22 caliber bullet fired from a Long Rifle cartridge—one shot on each side of the panel with no penetration.

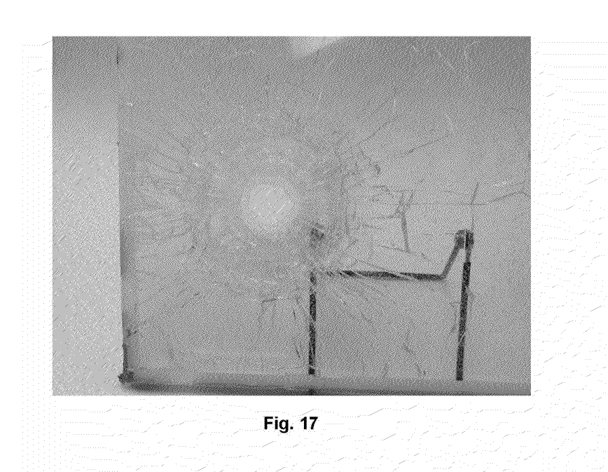

FIG. 17 shows small bubbles introduced during processing of two panes of ¼ inch glass coupled with ¼ in of polymer can cause micro-fractures, which then can cause undesirable ballistic failures of the polymer compared to FIGS. 15 and 16.

Although specific examples of the invention have been selected in the preceding disclosure as illustration in specific terms for the purpose of describing some forms of the invention fully and amply for one of average skill in the relevant art, it should be understood that various substitutions and modifications, which bring about substantially equivalent results and/or performance are deemed to be within the scope of the claims.

What is claimed is:

1. A ballistic resistant composite comprising a layer of transparent urethane polymer sufficient to block passage of a ballistic projectile through the layer.

2. The composite of claim 1, wherein the urethane polymer is made from a mixture comprising isocyanate blend components and polyol blend components.

3. The composite of claim 2, wherein the isocyanate blend components comprise 4,4-dicyclohexylmethane diisocyanate, 1,6-hexamethylene diisocyanate, and 1,6-hexamethylene diisocyanate.

4. The composite of claim 2, wherein the polyol blend components comprise Polyester Polyol 188, Polyester Polyol 366 and Polyester Polyol 337.

5. The composite of claim 2, wherein the urethane polymer is made from a mixture comprising an about equal part of about 73 wt % 4,4′-dicyclohexylmethane diisocyanate; about 23 wt % 1,6-hexamethylene diisocyanate; about 4 wt % 1,6-hexamethylene diisocyanate; mixed with an about equal part of about 95 wt % Polyester Polyol 188; about 3 wt % Polyester Polyol 366 and about 2 wt % Polyester Polyol 337 and up to about 4 wt % acetone.

6. The composite of claim 2, wherein the urethane polymer is a polymer of a mixture comprising 1,6-hexamethylene diisocyanate mixed with an about equal part of a mixture comprising about 96.7 wt % Polyester Polyol 8211; about 3 wt % Polyester Polyol 188; about 0.3 wt % Silquest A-189 silane and up to about 2 wt % urethane grade acetone.

7. The composite of claim 6, wherein the polymer is adjacent a transparent substrate that is more rigid than the polymer.

8. The composite of claim 7, wherein the substrate is glass.

9. The composite of claim 6, wherein the layer is polymerized on a transparent substrate selected from the group consisting of glass, plastic and acrylic.

10. The composite of claim 9, wherein the substrate is glass.

11. The composite of claim 1, wherein the polymer is positioned adjacent a transparent substrate.

12. The composite of claim 11, wherein the substrate is glass.

13. The composition of claim 1, wherein the polymer is a component of a thermal window and is retrofitted between two or more glass or acrylic panes that are components of the thermal window.

14. The composite of claim 1, wherein the polymer is polymerized on a transparent substrate.

15. The composite of claim 14, wherein the substrate is glass.

16. A method of resisting the penetration of a ballistic projectile comprising placing in the path of the projectile a transparent urethane polymer composition made from a mixture comprising isocyanate blend components and polyol blend components.

17. The method of claim 16, whereby the urethane polymer composition is polymerized on, or placed adjacent to, at least one clear, flat or curved surface made essentially of glass or plastic, wherein both the glass and plastic are harder than the urethane polymer.

18. The method of claim 17, wherein the urethane polymer is made from a mixture comprising 1,6-hexamethylene diisocyanate mixed with Polyester Polyol 8211, Polyester Polyol 188, and Silquest A-189 silane.

19. The method of claim 18, wherein the mixture comprises 1,6-hexamethylene diisocyanate mixed with an about equal part of a mixture comprising about 96.7 wt % Polyester Polyol 8211; about 3 wt % Polyester Polyol 188; about 0.3 wt % Silquest A-189 silane and up to about 2 wt % urethane grade acetone.

20. A method of manufacturing a transparent ballistic resistant polyurethane polymer comprising
a. Maintaining and mixing all components at about 38° F., mixing about 0.3 wt % Silquest A-189 silane and up to about 2 wt % urethane grade acetone to homogeneity;
b. Mixing about 96.7 wt % Polyester Polyol 8211 and about 3 wt % Polyester Polyol 188 to homogeneity to form a polyol blend;
c. Adding the mixture of step a to the polyol blend of step b and mixing to homogeneity;
d. Adding the mixture of step c to about an equal part of 1,6-hexamethylene diisocyanate and mixing to homogeneity.
e. Degassing the mixture of step d in a vacuum chamber at pressure below 0.4 in Hg until essentially all volatile components have been removed from the uncured liquid mixture.
f. Coating onto, or forming into, a suitable substrate the uncured liquid mixture and allowing the mixture to cure.
